(19) United States
(12) Patent Application Publication
(10) Pub. No.: US 2023/0420905 A1
(43) Pub. Date: Dec. 28, 2023

(54) APPARATUS AND METHOD FOR OPERATING ACOUSTO- OPTICAL DEFLECTORS

(71) Applicant: ELECTRO SCIENTIFIC INDUSTRIES, INC., Beaverton, OR (US)

(72) Inventors: Brian JOHANSEN, Beaverton, OR (US); Tyler HOWE, Tigard, OR (US); Mehmet ALPAY, Tigard, OR (US); James BROOKHYSER, Lake Oswego, OR (US); Jered RICHTER, Beaverton, OR (US)

(73) Assignee: ELECTRO SCIENTIFIC INDUSTRIES, INC., Beaverton, OR (US)

(21) Appl. No.: 18/253,997

(22) PCT Filed: Nov. 11, 2021
(86) PCT No.: PCT/US2021/058985

§ 371 Date: May 23, 2023

Related U.S. Application Data
(60) Provisional application No. 63/130,975, filed on Dec. 28, 2020.

(51) Int. Cl. H01S 3/106; G02F 1/33

(52) U.S. Cl. CPC H01S 3/1068; G02F 1/332; G02F 2203/22

(57) ABSTRACT

An apparatus includes an acousto-optical deflector (AOD) system operative to deflect a beam of laser energy within a two-dimensional scan field. The AOD system includes a first AOD operative to deflect the beam of laser energy along a first axis of the two-dimensional scan field; a second AOD arranged optically downstream of the first AOD, wherein the second AOD is operative to deflect the beam of laser energy along a second axis of the two-dimensional scan field; and a controller operatively coupled to the AOD system. The controller is configured to drive each of the first AOD and the second AOD to deflect the beam of laser energy within the two-dimensional scan field and is further configured to drive the first AOD and the second AOD at at least substantially the same diffraction efficiency.

### BACKGROUND

### I. Technical Field

Embodiments described herein relate generally laser-processing apparatuses and components thereof and to techniques for operating the same.

### II. Technical Background

Acousto-optic (AO) devices, sometimes referred to as Bragg cells, diffract and shift light using acoustic waves at radio frequency. These devices are often used for Q-switching, signal modulation in telecommunications systems, laser scanning and beam intensity control in microscopy systems, frequency shifting, wavelength filtering in spectroscopy systems. Many other applications lend themselves to using acousto-optic devices. For example, AO deflectors (AODs) can be used in laser-based materials processing systems.

Referring to FIG. 1, an AOD, such as AOD 100, generally includes AO cell 102, a transducer 104 attached to the AO cell 102 (i.e., at a transducer end of the AO cell 102) and can also include an acoustic absorber 106 attached to the AO cell 102 (i.e., at an absorber end of the AO cell 102, opposite the transducer end).

The AO cell 102 (also referred to as an “AO cell”) is typically a crystalline or glassy material that is suitably transparent to the wavelength of light to be diffracted. The transducer 104 is generally a piezoelectric transducer, and is operative to vibrate in response to an externally-applied RF signal (i.e., drive signal). The transducer 104 is attached to the AO cell 102 such that the vibrating transducer 104 creates a corresponding acoustic wave that propagates within the AO cell 102 (i.e., from the transducer end toward the acoustic absorber 106, along a diffraction axis of the AOD 100). As is known, the amplitude, frequency and duration of the acoustic wave correspond to the amplitude, frequency and duration of the applied RF drive signal. The acoustic wave is manifested within the AO cell 102 as periodic series of regions of expansion and compression, thereby creating a periodically changing refractive index within the AO cell 102. The periodically changing refractive index functions like an optical grating that can diffract a beam of laser light propagating through the AO medium. Although only one transducer 104 is illustrated, the AOD may include multiple transducers 104 acoustically coupled to the AO cell 102, which may are typically driven to enhance the bandwidth of the AOD and diffraction of light therein.

Diffracting the incident beam of laser light produces a diffraction pattern that typically includes zeroth- and first-order diffraction peaks, and may also include higher-order diffraction peaks (e.g., second-order, third-order, etc.). Within the art, it is common to refer to the portion of the diffracted beam of laser light in the zeroth-order diffraction peak as a “zeroth-order” beam, to refer to the portion of the diffracted beam of laser light in the first-order diffraction peak as a “first-order” beam, and so on. Generally, the zeroth-order beam and other diffracted-order beams (e.g., the first-order beam, etc.) propagate along different beam paths upon exiting the AO cell 102. For example, the zeroth-order beam propagates along a zeroth-order beam path, the first-order beam propagates along a first-order beam path, and so on. The angles between the zeroth- and other diffracted-order beam paths correspond to the frequency (or frequencies) in the drive signal that was applied to the transducer 104 to diffract the beam of laser light incident upon the AO cell 102.

Drive signals can be applied to an input of the transducer 104 by an RF driver 108. As shown in FIG. 1, an RF driver can include an RF synthesizer 110, an amplifier 112 and an impedance matching circuit 114. The RF synthesizer 110 (e.g., a DDS synthesizer) generates and outputs a preliminary signal of a desired frequency. The amplifier 112 amplifies the preliminary signal, thereby transforming the preliminary signal into the drive signal. The drive signal is then applied to the input of the transducer 104 via the impedance matching circuit 114.

Generally, the operation of the RF synthesizer 110 and the amplifier 112 can be controlled by a controller (not shown) to generate RF drive signals of different frequencies and amplitudes that can be rapidly applied (e.g., at rates up to or greater than 1 MHz) to a transducer 104 of an AOD 100. For purposes of facilitating disclosure, the act of applying an RF drive signal to a transducer 104 of an AOD 100 is also referred to herein as “driving” the AOD 100. By successively driving the AOD 100 using drive signals of different frequencies, the AOD 100 can be used to rapidly scan the first-order beam. As used herein, the term “diffraction efficiency” can be considered to refer to the proportion of energy in the incident beam of laser energy that the AOD 100 diffracts into the first-order beam. Diffraction efficiency may thus be represented as the ratio of the optical power diffracted into the first-order beam to the optical power of the incident beam of laser energy. The diffraction efficiency at which an AOD is driven can vary depending upon the frequency and amplitude of the applied drive signal. Thus, one technique for controlling the energy content of the first-order beam involves controlling the amplitude of the drive signal applied to the AOD to produce the first-order beam.

A multi-axis AOD system is commonly incorporated within a laser-based material processing system to rapidly scan a beam of laser energy (e.g., during material processing of a workpiece). The multi-axis AOD system will typically multiple AODs, such as AOD 100. For example, a multi-axis AOD system can include one AOD (e.g., a first AOD) arranged and configured to scan the beam of laser energy along a first axis, and another (e.g., a second AOD) arranged and configured to scan the beam of laser energy along a second axis. The second AOD is arranged in series with (i.e., optically downstream of) the first AOD such that a scan field associated with the second AOD is superimposed upon a scan field associated with the first AOD. FIGS. 2 and 3 illustrate different types of multi-axis AOD systems. A multi-axis AOD system can be incorporated within laser-processing system having a single processing head or multiple processing heads. An example of a multi-head laser-processing system incorporating a multi-axis AOD system is described in WO 2020/159666, which is incorporated herein by reference.

In FIGS. 2 and 3, the first AOD is identified at 100a and the second AOD is identified at 100b. Referring to FIG. 2, the first AOD 100a is arranged and configured to diffract a first-order beam within a first scan field (delineated by the dash-dot area) oriented within the X-Z plane and the second AOD 100b is arranged and configured to diffract a first-order beam output by the first AOD 100a within a second scan field (delineated by the dash-dot area) oriented within the Y-Z plane; thus, the scan field of the multi-axis AOD system is a superposition of the first and second scan fields and extends in the X-Y plane. Referring to FIG. 3, the first AOD 100a and the second AOD 100b are each arranged and configured to diffract a first-order beam within a scan field oriented within the X-Z plane, but one or more optical elements (illustrated generically at 300) are provided between the first AOD 100a and the second AOD 100b to rotate the image of the first-order beam output from the first AOD 100a by 90 degrees; thus, the scan field of the multi-axis AOD system is a superposition of the first and second scan fields and extends in the X-Y plane.

In the context of laser-material processing, one factor in considering the laser used to produce the incident beam of laser energy is often whether the laser can produce a beam of laser energy that, after having been diffracted by the multi-axis AOD system (and after having been reflected or transmitted by any other optical components in the beam path), still has an average or peak power sufficient to effect suitable material processing at a workpiece. According to the disclosure herein, “suitable material processing” is effected at a workpiece upon directing a beam of laser energy to the workpiece to form one or more vias, openings, channels, slots, kerfs, scribes, etc., therein without undesirably damaging the workpiece. Thus, in designing a laser processing system, it is conventional to match the laser (and other optical components in the beam path between the laser and the workpiece, such as the multi-axis AOD system) to the type of workpiece to be processed and to the particular type and quality of material processing to be performed on the workpiece. Thus, if two different types of workpieces both need to be laser-processed in some manner, then it is customary to simply provide two different laser systems, each with a laser that is suited to processing one of the different workpieces. For example, if a first printed circuit board (having a relatively thick top conductor) and a second printed circuit board (having a relatively thin top conductor) both need to be laser-processed to form vias therein, then it is conventional to provide a first laser system (e.g., with a first laser having power characteristics suitable for forming via openings in the relatively thick top conductor of the first workpiece) and a second laser system (e.g., with a second laser having power characteristics suitable for forming via openings in the relatively thin top conductor of the second workpiece).

### SUMMARY

One embodiment of the present invention can be broadly characterized as an apparatus that includes an acousto-optical deflector (AOD) system operative to deflect a beam of laser energy within a two-dimensional scan field. The AOD system includes a first AOD operative to deflect the beam of laser energy along a first axis of the two-dimensional scan field; a second AOD arranged optically downstream of the first AOD, wherein the second AOD is operative to deflect the beam of laser energy along a second axis of the two-dimensional scan field; and a controller operatively coupled to the AOD system. The controller is configured to drive each of the first AOD and the second AOD to deflect the beam of laser energy within the two-dimensional scan field and is further configured to drive the first AOD and the second AOD at at least substantially the same diffraction efficiency.

### BRIEF DESCRIPTION OF THE DRAWINGS

FIG. 1 schematically illustrates an acousto-optic deflector (AOD) and associated driver, according to one embodiment.

FIGS. 2 and 3 schematically illustrate different configurations of multi-axis AOD systems.

FIGS. 4 and 5 are timing diagrams illustrating techniques for effecting reliable, low-power operation of multi-axis AOD systems, such as those shown in FIGS. 2 and 3, in a manner that schematically illustrate multi-axis AOD systems according to some embodiments.

FIG. 6 schematically illustrates a laser-processing system having a multi-axis AOD system, according to some embodiments.

FIG. 7 schematically illustrates a technique for forming a blind via hole using the laser-processing system shown in FIG. 6, according to an embodiment.

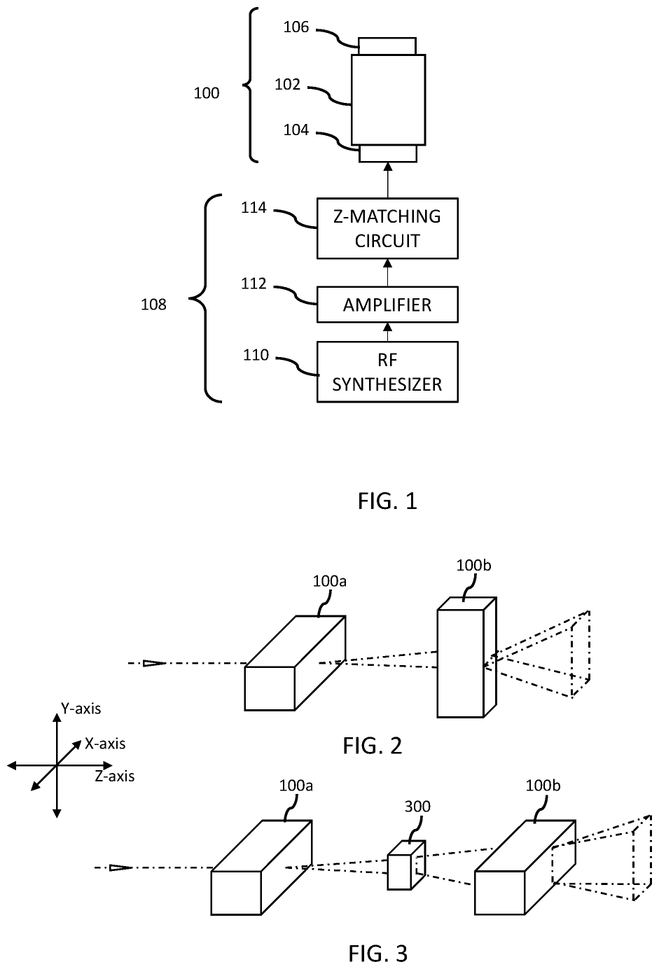

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, but are exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular example embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one node could be termed a “first node” and similarly, another node could be termed a “second node”, or vice versa.

Unless indicated otherwise, the term “about,” “thereabout,” “substantially,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Spatially relative terms, such as “below,” “beneath,” “lower,” “above,” and “upper,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

The section headings used herein are for organizational purposes only and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

### I. EMBODIMENTS CONCERNING PRODUCING HIGHLY-ATTENUATED BEAMS WITH MULTI-AXIS AOD SYSTEM, GENERALLY

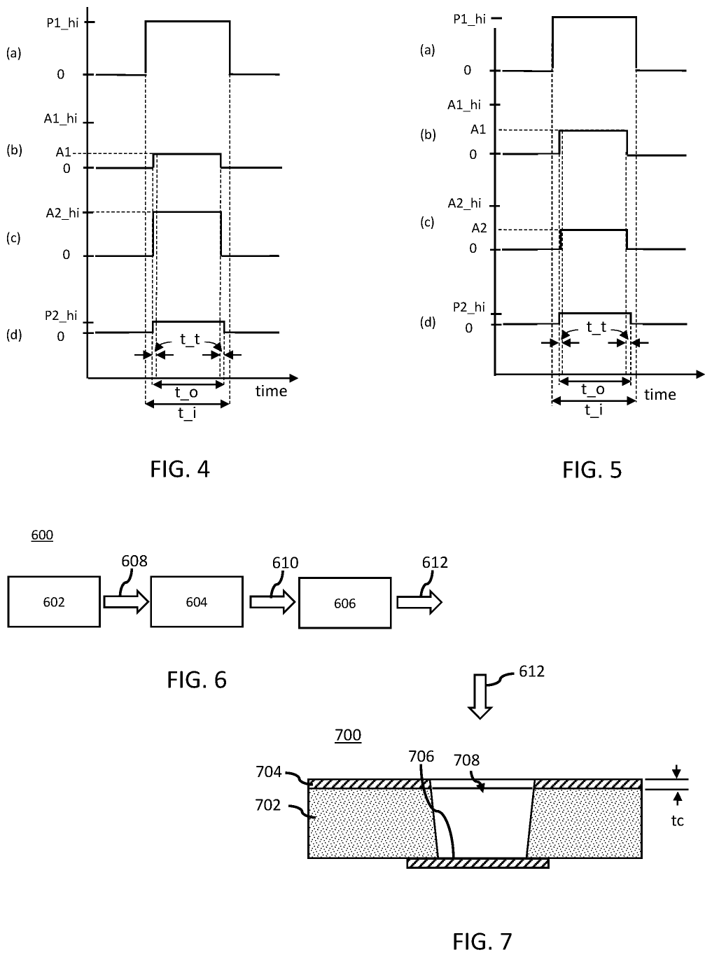

FIGS. 4 and 5 are timing diagrams illustrating techniques for operating multi-axis AOD systems, such as any of those shown in FIGS. 2 and 3, to produce highly-attenuated first-order beams.

In each of FIGS. 4 and 5, line (a) represents the power of an arbitrary beam of laser energy incident to the first AOD 100a of a multi-axis AOD system; line (b) represents an amplitude of a first acoustic wave propagating through an aperture of the first AOD 100a in response to a RF drive signal (i.e., a “first” RF drive signal) applied to the first AOD 100a of the multi-axis AOD system; line (c) represents an amplitude of a second acoustic wave propagating through an aperture of the second AOD 100a in response to a RF drive signal (i.e., a “second” RF drive signal) applied to the second AOD 100b of the multi-axis AOD system; and line (d) represents the power of the first-order beam output from the second AOD 100b of the multi-axis AOD system. As used herein, the first RF drive signal and the second RF drive signal can be considered a “set” of RF drive signals.

Although the power profile is represented by line (a) as having a generally constant peak power (i.e., P1_hi), it will be appreciated that the beam of laser energy incident to the first AOD 100a may have any other profile (e.g., corresponding to the laser source from which the beam of laser energy was generated). Likewise, although the power profile is represented by line (d) as having a generally constant peak power (i.e., P2_hi), it will be appreciated that the first-order beam of laser energy output from the second AOD 100b may have any other profile (e.g., corresponding to the power profile represented in line (a), corresponding to the rise and fall time of acoustic waves within the first AOD 100a and second AOD 100b, or the like or any combination thereof). Generally, however, the average power, peak power, or any combination thereof, of the first-order beam of laser energy output from the second AOD 100b can be less than or equal to 80%, 70%, 60%, 50%, 40%, 30%, 20%, 10%, 5%, 2%, 1%, 0.5%, 0.1%, etc., or between any of these values, of that of beam of laser energy incident to the first AOD 100a. Thus, the diffraction efficiency of the multi-axis AOD system (i.e., the ratio of the optical power diffracted into the first-order beam as output from the second AOD 100b to the optical power of the beam of laser energy incident upon the first AOD 100a) can be less than or equal to 80%, 70%, 60%, 50%, 40%, 30%, 20%, 10%, 5%, 2%, 1%, 0.5%, 0.1%, etc., or between any of these values. As such, the first-order beam output by the multi-axis AOD system can be referred to as a “highly-attenuated first-order beam.”

Further, although not illustrated, it will be appreciated that the first RF drive signal and second RF drive signal (and, thus, the acoustic waves generated therefrom) may be characterized by any frequency suitable to cause the multi-axis AOD system to direct the first-order beam to a suitable or desired location within the scan field of the multi-axis AOD system. The term “A1_hi” refers to the amplitude of a first acoustic wave propagating through the first AOD 100a and generated in response to the first RF signal applied to operate the first AOD 100a at a maximum diffraction efficiency, or to operate the first AOD 100a at the same maximum diffraction efficiency (or above a threshold diffraction efficiency) across a range of applied RF frequencies. Likewise, term “A2_hi” refers to the amplitude of a second acoustic wave propagating through the second AOD 100b and generated in response to the second RF signal applied to operate the second AOD 100b at a maximum diffraction efficiency, or to operate the second AOD 100b at the same maximum diffraction efficiency (or above a threshold diffraction efficiency) across a range of applied RF frequencies.

As is generally known, acoustic waves propagate through the AO cell 102 of an AOD (i.e., either of the first AOD 100a and second AOD 100b) at a rate of on the order of a few mm/μs, which is significantly slower than the speed of light (˜3×105 mm/μs). Accordingly, an RF drive signal must be applied before an aperture of the AOD is illuminated by laser energy that is to be diffracted by the acoustic wave.

Referring to FIGS. 4 and 5, the timing diagrams indicate that the first acoustic wave and the second acoustic wave are present at the aperture of the first AOD 100a and second AOD 100b, respectively, after the beam of laser energy is initially illuminates the apertures of the AODs in the multi-axis AOD system. Thus, the first AOD 100a and second AOD 100b do not diffract the beam of laser energy until after the beam of laser energy is initially incident upon the first AOD 100a, and a portion of the incident beam of laser energy is transmitted through the multi-axis AOD system (e.g., as a zeroth-order beam) before it is absorbed at a beam dump (not shown).

The beam of laser energy propagating through the first AOD 100a is diffracted by a first acoustic wave produced in response to the first RF drive signal applied to the first AOD 100a to produce, among others, a first-order beam. Likewise, the first-order beam propagating through the second AOD 100b is diffracted by a second acoustic wave produced in response to the second RF drive signal applied to the second AOD 100b to produce another first-order beam, among others. The first-order beam output from the second AOD 100b is hereinafter considered as the first-order beam that is output by the multi-axis AOD system. Laser energy in the zeroth-order beam (and any other high-order beams other than the first-order beam) can be absorbed at one or more beam dumps (not shown) in any suitable or desired manner.

After the first and second acoustic waves have propagated through the apertures of the first AOD 100a and the second AOD 100b, respectively, the first-order beam ceases to be output from the multi-axis AOD system, and the resulting zeroth-order beam is absorbed at one or more beam dumps (not shown) in any suitable or desired manner.

As will be appreciated from the foregoing, the act of applying the first RF drive signal and second RF drive signal, each of finite duration (i.e., t_o), results in the temporal division of the incident beam of laser energy (i.e., a laser pulse having a pulse duration of t_i, where t_i is greater than t_o) into a first-order beam (i.e., a laser pulse having a pulse duration of t_o). In view of the above, it will also be appreciated that t_o can be at least substantially equal to t_i (i.e., equal to, or slightly greater than or slightly less than t_i). It will also be appreciated that the incident beam of laser energy can be manifested as a continuous or quasi-continuous beam of laser energy (i.e., as a CW or QCW beam of laser energy) instead of as a pulse or series of pulses.

Although FIGS. 4 and 5 illustrate a driving technique that results in temporally dividing the incident beam of laser energy into a first-order beam only once (i.e., by applying one set of RF signals), it will be appreciated that the incident beam of laser energy may be temporally divided into a series of first-order beams by sequentially applying sets of RF drive signals (i.e., by sequentially applying different sets of first and second RF drive signals). As used herein, two sequentially-applied sets of RF drive signals are different from one another if the amplitude and/or frequency of a RF drive signal (e.g., the first RF drive signal) in one set of RF drive signals is different from the amplitude and/or frequency of a corresponding RF drive signal (e.g., the first RF drive signal) in the other set of RF drive signals. Lastly, although the incident beam of laser energy has been described above as consisting of a single laser pulse having a pulse duration of t_i, it will be appreciated that the incident beam of laser energy may be manifested as a series of laser pulses. Accordingly, one or more (or all) laser pulses in the incident beam of laser energy may be temporally divided in any manner according to the embodiments described herein.

As used herein, t_i and t_o may each be measured as the full-width at half-maximum (FWHM) of the optical power in the beam of laser energy versus time. Generally, t_i can be any duration that is greater than or equal to (or at least substantially equal to) the transit time of an acoustic wave through the aperture of either AOD in the multi-axis AOD system (e.g., the first AOD 100a) that is illuminated by the incident beam of laser energy. The transit time is thus determined by the acoustic velocity of the material from which the AO cell is formed and the size of the aperture. The AO cell can be formed of any suitable material such as Ge, LiNbO3, PbMoO4, TeO2, GaAs, GaP, glassy SiO2, quartz, As2S3, or the like. Exemplary acoustic velocities of materials from which the AO cell can be made can be in a range of about 2 mm/μs to about 7 mm/μs. The size of the aperture of an AOD may correspond to the size of the beam size of the beam of the beam of laser energy incident to the AOD. As used herein, the term “beam size” refers to the diameter or width of a laser pulse, and can be measured as a radial or transverse distance from the beam axis to where the optical intensity drops to 1/e2 of the optical intensity at the axis of propagation along the beam path 116. According to embodiments discussed herein, the beam size may be in a range from 0.25 mm (or thereabout) to 10 mm (or thereabout). It should be appreciated that the material from which the AO cell is formed will depend upon the wavelength of the beam of laser energy that is incident upon the AO cell. Thus, the beam of laser energy incident upon the AODs of the multi-axis AOD system may have a wavelength in a range from 200 nm (or thereabout) to 12 μm (or thereabout), and such beam of laser energy may be generated by any suitable means known in the art.

While t_o can be less than t_i, it should be noted there may be practical considerations limiting how brief t_o can be. Specifically, the act of applying an RF drive signal to a transducer of an AOD can induce a transient response within the AO cell. The transient response is manifested in the acoustic wave that propagates through the AO cell, existing for a brief amount of time (also referred to herein as a “transient period”) immediately after the RF drive signal is applied to the AOD and immediately after the RF drive signal ceases to be applied. These transient periods are exemplarily indicated in FIGS. 4 and 5 at “t_t”. During a transient period, the actual power of the first-order beam output by each AOD in the multi-axis AOD system (and, thus, the multi-axis AOD system itself) may be less than the expected power (e.g., given the amplitude of the RF drive signal). The spot shape of the first-order beam output by each AOD in the multi-axis AOD system (and, thus, the multi-axis AOD system itself) may also be distorted (e.g., elongated, along the diffraction axis of the AOD) during a transient period. Among other factors, the duration of each transient period can correspond (e.g., be at least approximately or substantially equal to, or otherwise proportional to) to the transit time. Thus, it can be preferable to drive the first AOD 100a and the second AOD 100b such that t_o is greater than the twice the transit time. In some embodiments, t_o is greater than or equal to 0.25 μs (or thereabout). For example, t_o may be greater than or equal to 0.25 μs, 0.5 μs, 0.75 μs, 1 μs, 1.5 μs, 2 μs, 4 μs, etc., or between any of these values. Notwithstanding the foregoing, in some embodiments, it can be acceptable to drive the first AOD 100a and the second AOD 100b such that t_o is equal to or less than the twice the transit time t_t.

### A. First Embodiment

In the embodiment shown in FIG. 4, the first amplitude, A1, of the first RF drive signal applied to the first AOD 100a is well below A1_hi, and the second amplitude, A2, of the second RF drive signal applied to the second AOD 100b is equal to (or at least substantially equal to) A2_hi. Generally, the first amplitude A1 is less than 80% (or thereabout) of A1_hi. For example, the first amplitude A1 can be less than or equal to 75%, 70%, 60%, 50%, 40%, %, 20%, 10%, 5%, 2%, 1%, 0.5%, 0.1% of A1_hi, or between any of these values. In response to the first RF drive signal, the first AOD 100a can thus be driven at a diffraction efficiency that is less than or equal to 75%, 70%, 60%, 50%, 40%, 30%, 20%, 10%, 5%, 2%, 1%, 0.5%, 0.1%, etc., or between any of these values. Notwithstanding the foregoing, in some embodiments, it can be acceptable to set the first amplitude A1 to any value in a range between A1_hi and 80% of A1_hi. It will also be appreciated that the second amplitude A2 may be less than A2_hi, so long as the second amplitude is greater than the first amplitude A1.

By limiting the amplitude of the first RF signal applied to the first AOD 100a as discussed above, the range in diffraction efficiencies over which the second AOD 100b can operated significantly increases the resolution with which the energy content of the highly-attenuated first-order beam (as output by the multi-axis AOD system) can be controlled. However, this beneficial increase in output resolution is not observed if the driving technique discussed with respect to FIG. 4 is reversed (i.e., by setting the first amplitude A1 equal to A1_hi and setting the applied second amplitude A2 to be well below A2_hi).

Further, because the second amplitude A2 is greater than the first amplitude A1, the magnitude of the spot shape distortion of the first-order beam output by the second AOD 100b will be greater than the magnitude of the spot shape distortion of the first-order beam output by the second AOD 100b during transient periods. As a result, the spot shape of the highly-attenuated first-order beam output by the multi-axis AOD system may be somewhat distorted (i.e., elongated along the Y-axis of the scan field multi-axis AOD system, which corresponds to the diffraction axis of the second AOD 100b) during transient periods.

### B. Second Embodiment

In the embodiment shown in FIG. 5, the first amplitude A1 is well below A1_hi, and the second amplitude A2 is well below A2_hi. Generally, the first amplitude A1 is less than 90% (or thereabout) of A1_hi, and the second amplitude A2 is less than 90% (or thereabout) of A2_hi. For example, the first amplitude A1 can be less than or equal to (or about equal to) 90%, 80%, 70%, 60%, 50%, 40%, 30%, 20%, 10%, 5%, 2%, 1%, 0.5%, 0.1% of A1_hi, or between any of these values. Likewise, the second amplitude A2 can be less than or equal to (or about equal to) 90%, 80%, 70%, 60%, 50%, 40%, 30%, 20%, 10%, 5%, 2%, 1%, 0.5%, 0.1% of A2_hi, or between any of these values. In response to the first and second RF drive signals, the first AOD 100a and second AOD 100b, respectively, can be driven at corresponding diffraction efficiencies that are less than or equal to (or about equal to) 90%, 80%, 70%, 60%, 50%, 40%, 30%, 20%, 10%, 5%, 2%, 1%, 0.5%, 0.1%.

In one embodiment, the first amplitude A1 and second amplitude A2 are equal to (or at least substantially equal to) one another. By setting the first amplitude A1 and second amplitude A2 in this manner, the magnitude of the spot shape distortion of the first-order beam output by the first AOD 100a will be at least substantially equal to the magnitude of the spot shape distortion of the first-order beam output by the second AOD 100b during transient periods. As a result, the spot shape of the highly-attenuated first-order beam output by the multi-axis AOD system may be at least substantially equally distorted (i.e., elongated along the X- and Y-axes of the scan field multi-axis AOD system) during transient periods. By setting the first amplitude A1 and second amplitude A2 to be equal to (or at least substantially equal to) one another, it will be appreciated that the diffraction efficiency of each of the first AOD 100a and the second AOD 100b is equal to (or is at least substantially equal to) the square root of the desired diffraction efficiency of the multi-axis AOD system. For example, if it is desired to operate the multi-axis AOD system at a diffraction efficiency of 50%, then each of the first AOD 100a and second AOD 100b can be operated at a diffraction efficiency of about 70% (i.e.,

$$\sqrt[2]{0.5} = 0.7 \; 07 ) .$$

Notwithstanding the foregoing, in another embodiment, it can be acceptable to set the first amplitude A1 to be different from (e.g., higher or lower than) the second amplitude A2, so long as the spot shape distortion produced by the magnitude difference is within acceptable limits.

### II. EXAMPLE EMBODIMENT CONCERNING LASER PROCESSING SYSTEM WITH MULTI-AXIS AOD SYSTEM

According to some embodiments, the multi-axis AOD system described with reference to any of FIG. 2 or 3 may be incorporated within a laser-processing system, such as laser-processing system 600 shown in FIG. 6. Referring to FIG. 6, the laser-processing system 600 includes a laser 602, a multi-axis AOD system 604 (i.e., provided as described with reference to any of FIG. 2 or 3), a scan lens 606.

Generally, the laser 602 is operative to generate a beam of laser energy 608, which may be propagated to the multi-axis AOD system 604. The laser 602 may, for example, be provided as any laser suitable for producing either a continuous beam of laser energy or a pulse or quasi-continuous beam of laser energy manifested as a series of laser pulses having a pulse duration (i.e., based on the full-width at half-maximum (FWHM) of the optical power in the pulse versus time) that is greater than or equal to (or about equal to) 0.25 μs (e.g., greater than or equal to 0.25 μs, 0.5 μs, 0.75 μs, 1 μs, 1.5 μs, 2 μs, 5 μs, 10 μs, 15 μs, 20 μs, 40 μs, 50 μs, 100 μs, 200 μs, 500 μs, 1 ms, 20 ms, 50 ms, 100 ms, 500 ms, 1 s, etc., or between any of these values). Examples of types of lasers that can be provided as laser 602 include gas lasers (e.g., carbon dioxide lasers, carbon monoxide lasers, excimer lasers, etc.), CW- and QCW-fiber lasers, and the like. Depending on the particular laser employed, the beam of laser energy 608 output by the laser 602 can have one or more wavelengths in the ultraviolet (UV), visible or infrared (IR) range of the electromagnetic spectrum.

The multi-axis AOD system 604 is operative to diffract the incident beam of laser energy 608 so as to produce a first-order beam 610, as discussed above. Generally, the multi-axis AOD system 604 can be operated to produce a highly-attenuated first-order beam, as discussed above, as the first-order beam 610. Optionally, the multi-axis AOD system 604 can also be operated to scan the highly-attenuated first-order beam 610 within a scan field thereof (e.g., by modulating the frequency of RF drive signals applied to any of the aforementioned first AOD 100a and second AOD 100b. Notwithstanding the foregoing, the multi-axis AOD system 604 can also be operated so as to produce a first-order beam 610 having an average power, peak power, or any combination thereof, that is greater than 80% (e.g., greater than or equal to 80%, 90%, 95%, 98%, 99%, etc., or between any of these values), of that of the incident beam of laser energy 608. The first-order diffracted beam 610 can be propagated to the scan lens 606.

The scan lens 606 is operative to focus the first-order diffracted beam 610, thereby producing a focused beam of laser energy 612. The focused beam of laser energy 612 is typically propagated (e.g., as a Gaussian beam) to a workpiece (not shown) to effect material processing thereon.

Although not illustrated, the laser-processing system 600 will typically include one or more other optical components (e.g., beam expanders, apertures, filters, collimators, lenses, mirrors, polarizers, wave plates, diffractive optical elements, refractive optical elements, or the like or any combination thereof) to focus, expand, collimate, polarize, filter, or otherwise modify, condition, direct, monitor, analyze, etc., the laser energy—in all of varied forms (i.e., as beams 608, 610 and/or 612)—as it propagates from the laser 602 to the scan lens 606 and, optionally, to the workpiece to be processed.

Optionally, the laser-processing system 600 includes one or more beam positioners (not shown) operative to scan the beam of laser energy as it propagates within the laser-processing system 600. Any beam positioner may be arranged optically upstream of the multi-axis AOD system 604, optically downstream of the multi-axis AOD system 604, or a combination thereof. The beam positioner can be provided as a galvanometer mirror, another AOD, an electro-optic (EO) deflector (EOD), a fast-steering mirror (FSM), a rotating polygon scanner, or the like or any combination thereof. Depending on the type, the scan field of the beam positioner may be larger than, equal to or less than (i.e., in terms of size or angular range) the scan field of the multi-axis AOD system 604. Likewise, the maximum scan rate of the beam positioner (i.e., maximum rate at which the beam positioner can reliably position the beam of laser energy at a specified position within its scan field) will likely be less than or equal to the maximum scan rate of the multi-axis AOD system 604.

Although not illustrated, the laser-processing apparatus 600 includes one or more controllers configured to control the operation of the laser 602, the multi-axis AOD system 604 and any other components that can be operated in a controllable manner (e.g., a beam positioner).

As is known in the art, a controller can include one or more processors operative to generate one or more control signals, upon executing instructions, to control the operation of the RF driver driving each AOD in the multi-axis AOD system 604. A processor can be provided as a programmable processor (e.g., including one or more general purpose computer processors, microprocessors, digital signal processors, or the like or any combination thereof) operative to execute the instructions. Instructions executable by the processor(s) may be implemented software, firmware, etc., or in any suitable form of circuitry including programmable logic devices (PLDs), field-programmable gate arrays (FPGAs), field-programmable object arrays (FPGAs), application-specific integrated circuits (ASICs)—including digital, analog and mixed analog/digital circuitry—or the like, or any combination thereof. Execution of instructions can be performed on one processor, distributed among processors, made parallel across processors within a device or across a network of devices, or the like or any combination thereof. As is known in the art, the controller can include tangible media such as computer memory, which is accessible (e.g., via one or more wired or wireless communications links) by the processor. As used herein, “computer memory” includes magnetic media (e.g., magnetic tape, hard disk drive, etc.), optical discs, volatile or non-volatile semiconductor memory (e.g., RAM, ROM, NAND-type flash memory, NOR-type flash memory, SONOS memory, etc.), etc., and may be accessed locally, remotely (e.g., across a network), or a combination thereof. Generally, the instructions may be stored as computer software (e.g., executable code, files, instructions, etc., library files, etc.), which can be readily authored by artisans, from the descriptions provided herein, e.g., written in C, C++, Visual Basic, Java, Python, Tel, Perl, Scheme, Ruby, assembly language, hardware description language (e.g., VHDL, VERILOG, etc.), etc. Computer software is commonly stored in one or more data structures conveyed by computer memory.

In view of the above, and with reference to FIG. 7, it should be appreciated that the laser 602 is operative to generate a beam of laser energy 608 having sufficiently high average or peak power such that, after the laser energy is diffracted by the multi-axis AOD system 604 and transmitted by the scan lens 606, the energy content of the resulting focused beam of laser energy 612 is sufficient to effect material processing of different types of workpieces without undesirably damaging the workpieces. In one embodiment, the laser-processing apparatus 600 may be provided as a laser-processing system according to any of the embodiments described in WO 2020/159666, which is incorporated herein by reference.

### III. EXAMPLE TECHNIQUE FOR EFFECTING MATERIAL PROCESSING OF A WORKPIECE

In one embodiment, and with reference to FIG. 7, workpieces that may be processed using the laser-processing system 600 can be generally classified as a printed circuit board (PCB). Referring to FIG. 7, workpiece 700 (i.e., a PCB) includes a dielectric structure 702 having a first side that is contacted by, or otherwise adhered to, a first electrical conductor structure 704 (also referred to herein as a “top conductor”). The dielectric structure 702 may be provided as a material such as FR4, polyimide, liquid crystal polymer, ABF, etc. The first electrical conductor structure 704 may be provided as a film or foil formed of a material such as copper or a copper alloy. The first electrical conductor structure 704 may have a thickness in a range from 15 μm (or thereabout) to 1 μm (or thereabout). For example, the first electrical conductor structure 704 may have a thickness equal to (or about equal to) 15 μm, 12 μm, 9 μm, 7 μm, 5 μm, 2 μm, 1.5 μm, 1 μm, etc., or between any of these values. In some embodiments, however, the thickness of the first electrical conductor structure 704 can be greater than 15 μm. Optionally, the upper surface of the first electrical conductor structure 704 can be treated, e.g., by a chemical reaction, by a laser-darkening process, etc., to increase absorption of laser energy. Optionally, the workpiece 700 includes another electrical conductor structure, such as second electrical conductor structure 706 (e.g., a pad, a trace, etc., formed of copper or a copper alloy, or the like) in contact with, or otherwise adhered to, a second side of the dielectric structure 702 that is opposite the first side.

The workpiece 700 may be processed using the laser-processing system 600 to form, by any suitable technique, a feature such as blind via hole (BVH), through-hole (LTH) or other opening, trench, slot, recessed region, or the like. For example, a blind via hole (BVH) 708 can be formed in the workpiece 700 by directing the focused beam of laser energy 612 onto the workpiece 700 (e.g., such that the beam waist of the focused beam of laser energy 612 is at or near the surface of the workpiece 700) so as to form an opening in the first electrical conductor structure 704 and remove the dielectric structure 702 there below. In this example, the focused beam of laser energy 612 may have a wavelength of greater than 9 μm (or thereabout). The feature (in this example, the blind via hole 708) can be formed by a “punch” process (in which the axis along which the focused beam of laser energy 612 propagates remains stationary relative to the workpiece 700) or can be formed by a “trepan” or “raster” process (in which the axis along which the focused beam of laser energy 612 propagates is moved or repositioned relative to the workpiece 700). In the event that the feature is formed by a “trepan” or “raster” process, the focused beam of laser energy 612 can be scanned (e.g., by suitably operating the multi-axis AOD system 604, one or more beam positioners, or the like or any combination thereof).

According to the embodiments discussed above, the diffraction efficiency at which the multi-axis AOD system 604 is operated during workpiece processing corresponds to: the average or peak power of the beam of laser energy 608 output by the laser 602; the overall optical losses in the laser-processing apparatus 600; and the thickness, tc, of the first electrical conductor structure 704. In this case, the diffraction efficiency at which the multi-axis AOD system 604 is operated is sufficiently high so as to enable the feature to be formed, but is sufficiently low so as to prevent the workpiece 700 from becoming damaged during processing (and to enable the feature to be formed within standards of acceptable quality). For example (and assuming that the average or peak power of the beam of laser energy 608 output by the laser 602, and the overall optical losses in the laser-processing apparatus 600, remain at least substantially constant), if the thickness of the first electrical conductor structure 704 is within a first thickness range, then the multi-axis AOD system 604 can be operated at a corresponding first diffraction efficiency; if the thickness of the first electrical conductor structure 704 is within a second thickness range (of smaller thicknesses than the first thickness range), then the multi-axis AOD system 604 can be operated at a corresponding second diffraction efficiency (lower than the first diffraction efficiency); if the thickness of the first electrical conductor structure 704 is within a third thickness range (of smaller thicknesses than the second thickness range), then the multi-axis AOD system 604 can be operated at a corresponding third diffraction efficiency (lower than the second diffraction efficiency); and so on. As another example, if a thickness range encompasses thicknesses greater than 9 μm, then the multi-axis AOD system 604 can be operated at a diffraction efficiency that is greater than or equal to 80% (e.g., greater than or equal to 85%, 90%, 95%, or between any of these values); however, if another thickness range encompasses thicknesses less than 2 μm, then the multi-axis AOD system 604 can be operated at a diffraction efficiency that is less than 80% (e.g., less than or equal to 75%, 70%, 65%, 60%, 55%, 50%, 40%, 30%, 20%, 10%, 5%, 2%, 1%, 0.5%, 0.1%, etc., or between any of these values).

### IV. CONCLUSION

The foregoing is illustrative of embodiments and examples of the invention, and is not to be construed as limiting thereof. For example, in addition to, or as an alternative to, the RF amplitude modulation techniques discussed above with respect to FIGS. 4 and 5, highly-attenuated first-order beams may be generated by providing at least one AOD in the multi-axis AOD system as an AOD that includes multiple transducers 104 acoustically coupled to a common AO cell 102. In this case, the transducers 104 may be driven so as to generate acoustic waves within the AO cell 102 of equal frequency but slightly out of phase with one another so as to interfere in a slightly destructive manner, thereby decreasing the diffraction efficiency at which the AOD is driven. In another example, in addition to, or as an alternative to, any of the techniques described above, a bulk modulator or optical mode switch may be arranged in the beam path optically upstream of the multi-axis AOD system 604, and may be operated to selectively attenuate the beam of laser energy 608 before it enters into the multi-axis AOD system 604.

Furthermore, although embodiments have been discussed above in which t_o is less or at least substantially equal to t_i, it will be appreciated that t_o can be greater than t_i. Further still, although the embodiments described above with respect to FIGS. 4 and 5 have been discussed with respect to multi-axis AOD systems consisting of two AODs, it will be appreciated that the embodiments described above may likewise be applied to multi-axis AOD systems consisting of more than two AODs (e.g., to multi-axis AOD systems consisting of three AODs, four AODs, etc.). In this case, it will be appreciated that the embodiment described above with respect to FIG. 5 can be modified based on the number of AODs provided. For example if a three-AOD multi-axis AOD system (i.e., a multi-axis AOD system consisting of three AODs) is to be operated at a desired diffraction efficiency, then each of the three AODs can be operated at a diffraction efficiency equal to (or at least substantially equal to) the cube root of the desired diffraction efficiency of the three-AOD multi-axis AOD system. If a four-AOD multi-axis AOD system (i.e., a multi-axis AOD system consisting of four AODs) is to be operated at a desired diffraction efficiency, then each of the four AODs can be operated at a diffraction efficiency equal to (or at least substantially equal to) the fourth root of the desired diffraction efficiency of the four-AOD multi-axis AOD system. Generalizing, if an n-AOD multi-axis AOD system (i.e., a multi-axis AOD system consisting of n AODs, where n is any integer greater than 2) is to be operated at a desired diffraction efficiency, then each of the n AODs can be operated at a diffraction efficiency equal to (or at least substantially equal to) the nth root of the desired diffraction efficiency.

Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. Accordingly, all such modifications are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

What is claimed is:

1. An apparatus, comprising:
an acousto-optical deflector (AOD) system operative to deflect a beam of laser energy within a two-dimensional scan field, the AOD system including:
a first AOD operative to deflect the beam of laser energy along a first axis of the two-dimensional scan field;
a second AOD arranged optically downstream of the first AOD, wherein the second AOD is operative to deflect the beam of laser energy along a second axis of the two-dimensional scan field; and
a controller operatively coupled to the AOD system, wherein the controller is configured to drive each of the first AOD and the second AOD to deflect the beam of laser energy within the two-dimensional scan field, and wherein the controller is further configured to drive the first AOD and the second AOD at at least substantially the same diffraction efficiency.

2. The apparatus of claim 1, wherein the controller is further configured to drive each of the first AOD and the second AOD at a diffraction efficiency of less than 80%.

3. The apparatus of claim 2, wherein the controller is further configured to drive each of the first AOD and the second AOD at a diffraction efficiency of less than 70%.

4. The apparatus of claim 3, wherein the controller is further configured to drive each of the first AOD and the second AOD at a diffraction efficiency of less than 50%.

5. The apparatus of claim 1, wherein the controller is further configured to drive each of the first AOD and the second AOD to temporally divide a laser pulse from the beam of laser energy.

6. The apparatus of claim 1, wherein the beam of laser energy comprises a laser pulse and wherein the is configured to drive each of the first AOD and the second AOD to deflect the entire laser pulse.

7. The apparatus of claim 1, further comprising a scan lens arranged optically downstream of the AOD system.

8. The apparatus of claim 1, further comprising a laser operative to generate the beam of laser energy.

9. The apparatus of claim 8, wherein the beam of laser energy has a wavelength in the infrared range of the electromagnetic spectrum.

10. The apparatus of claim 8, wherein the beam of laser energy has a wavelength in the ultraviolet range of the electromagnetic spectrum.

11. The apparatus of claim 1, wherein the controller is configured to control the diffraction efficiency at which at least one AOD selected from the group consisting of the first AOD and the second AOD is driven by controlling an amplitude of an RF drive signal applied to the at least one AOD selected from the group consisting of the first AOD and the second AOD.

12. The apparatus of claim 1, wherein at least one selected from the group consisting of the first AOD and second AOD includes an acousto-optic cell having a plurality of transducers attached thereto and wherein the controller is configured to control the diffraction efficiency at which the at least one AOD selected from the group consisting of the first AOD and the second AOD is driven by controlling a phase with which an RF drive signal is applied to each transducer of the at least one AOD selected from the group consisting of the first AOD and the second AOD.
